(19) United States
(12) Patent Application Publication
(10) Pub. No.: US 2017/0239025 A1
(43) Pub. Date: Aug. 24, 2017

(54) DEVICE FOR CLEANING BETWEEN TEETH

(71) Applicant: Mircea Gutu, Lafayette, NJ (US)

(72) Inventor: Mircea Gutu, Lafayette, NJ (US)

(21) Appl. No.: 14/521,402

(22) Filed: Oct. 22, 2014

(51) Int. Cl. A61C 15/00; A61C 19/06; A61C 3/12; A61C 3/06

(52) U.S. Cl. CPC A61C 15/00; A61C 3/06; A61C 19/066; A61C 3/12

(57) ABSTRACT

A device for cleaning interproximal surfaces and contact areas between someone's teeth comprising at least one prophylaxis strip and a support member integral with the strip, which provides structural support, without impeding the ability of at least one end of the strip to be inserted between the teeth from the side.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD

The present application relates to cleaning between teeth, and specifically to prophylaxis strips.

### BACKGROUND

There are numerous devices for cleaning between your teeth: toothpicks, dental floss and more recently prophylaxis strips for cleaning interproximal surfaces and contact areas between teeth.

Tooth picks are used to push objects that are stuck between someone's teeth, from the outside into the mouth. However, they are actually more typically used to pry out materials from between. The technique used to pry an object out is inserting the tip of the toothpick near the gumline, and under the suck object, and then trying to pry the object up and out. While toothpicks can be used to effectively remove objects, they lack the ability to effectively clean the interior surfaces between teeth.

Typically, dental floss comprises a string material, such as cotton, that is of an appropriate diameter to pass between the teeth as aid in cleaning the surfaces between someone's teeth. The technique used is that the floss is inserted between the teeth down below the gum line and then rubbed along the teeth from the bottom to the top. Foreign material is then dragged out from between the teeth by either adhering to the cotton material or being pulled along with it. However, dental floss lacks the ability to push objects into the mouth. Additionally, the fiber material of dental floss is too soft to effectively remove tartar and other stain material from the surface of teeth.

Prophylaxis strips are more efficient at cleaning the interior surfaces of teeth in that they clean the entire interior surface of the teeth by moving the strip back and forth between the teeth (rather than up and down). As a of the back and forth motion they simultaneously clean the interior surfaces and drag foreign material out from between the teeth. However, like dental floss prophylaxis strips lack the structural stiffness to be used to push objects out from between teeth.

With prophylaxis strips, if the object is too big, such that the object and the strip cannot fit simultaneously between the teeth, then there is little hope of removing the foreign material other than dragging the strip over top of it and potentially risking further imbedding the object or potentially pushing the object below the gumline.

Attempts, to provide structural support to a prophylaxis strips typically involve inserting the prophylaxis strip into a device similar to a miniature hacksaw, where the strip is anchored at both ends by a support member. While this configuration does provide additional stability to the strip, the anchors at the ends prevent the strip from being used to push objects from between the teeth and into the mouth. As a result of the ends being constrained, the strip can only inserted between the teeth from the crown of the teeth towards the gumline and not from the side.

Therefore, there continues to be a need for prophylaxis strips that have sufficient structural support to allow foreign material to be pushed into the mouth, using materials that are safe for use by consumers.

### SUMMARY

In order to overcome the deficiencies in the prior art, systems and methods are described herein.

One aspect of the claimed invention involves a device for cleaning interproximal surfaces and contact areas between someone's teeth comprising at least one thin flexible strip with an overall thickness that fits between the teeth and a support member integral with the strip along its longitudinal length, which provides structural support, without impeding the ability of at least one end of the strip to be inserted between the teeth from the side and wherein the at least one end can be used to push material from between the teeth.

Another aspect involves a multisided prophylaxis strip that is separated by a structural support that does impede the ends of the multisided prophylaxis strip from being inserted between someone's teeth from the side.

These and other aspects described herein present in the claims result in features and/or can provide advantages over current technology.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages or features are mutually exclusive or contradictory, in that they cannot be simultaneously present in a single embodiment. Similarly, some advantages are applicable to one aspect of the invention, and inapplicable to others. Thus, the elaborated features and advantages should not be considered dispositive in determining equivalence. Additional features and advantages of the invention will become apparent in the following description, from the drawings, and from the claims.

### BRIEF DESCRIPTION OF THE DRAWINGS

This disclosure is further described in the detailed description that follows, with reference to the drawings, in which:

FIG. 1 (Prior Art) shows the use of a prophylaxis strip;

FIGS. 2A and 2B show, in simplified form, the use of a prophylaxis strip to remove a foreign object;

FIG. 3A-3C show, in simplified form, alternate versions of prophylaxis strip assembly from FIG. 2A-2B;

FIG. 4A-4B show, in simplified form representative two-sided prophylaxis strip assemblies,

FIG. 5 shows, in simplified form representative three-sided prophylaxis strip assembly;

FIG. 6 shows, in simplified form representative four-sided prophylaxis strip assembly.

### DETAILED DESCRIPTION

The instant devices and approach provide a way for cleaning interproximal surfaces and contact areas between teeth using a prophylaxis strip that has an added structural support longitudinally that still allows the end of the strip to be inserted between teeth to push foreign material from between the teeth.

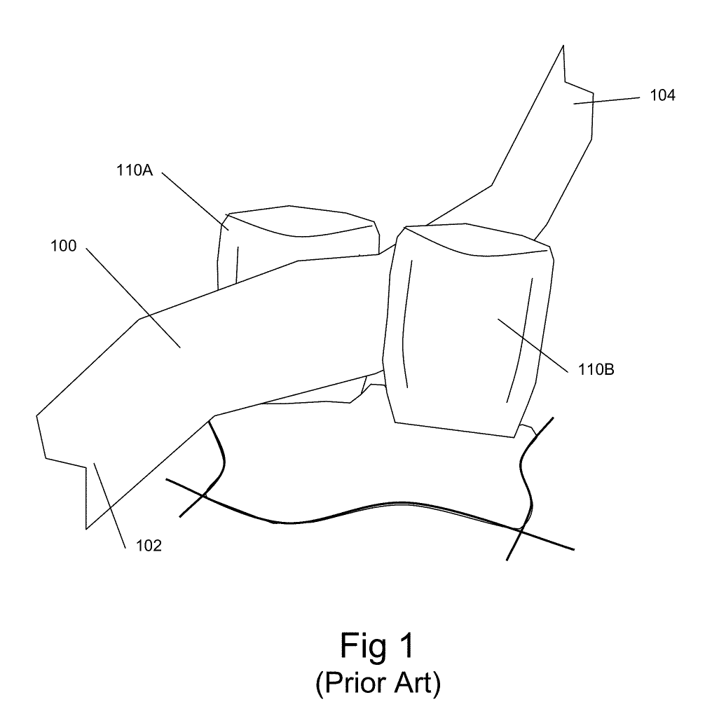

In order to understand the advantages of the instant devices it is helpful to examine current techniques for using prophylaxis strips. FIG. 1 (Prior Art) shows the standard use of a prophylaxis strip 100 that is used to clean the surface between someone's teeth 110A, 110B by pulling it back and forth by grasping the two ends 102,104. This is used in a similar fashion to dental floss.

In the case of FIG. 1 (Prior Art) depending on the material selected it is not possible to use the end of the prophylaxis strip to push a foreign object from between a person's teeth. It is only possible to draw a foreign object out by either dragging the strip over the top of the object or by getting the strip between one of the person's teeth and the object and then using the side of the strip to drag the foreign object out. The latter of technique may or may not be possible depending on the size of the foreign object and the former technique, if not successful in removing the object, may simply push the object closer to the patient's gums.

In contrast, the instant devices provide structural support along the longitudinal length of prophylaxis strip and leaves the ends clear such that the ends of the prophylaxis strip can be used to push foreign objects from between the person's teeth.

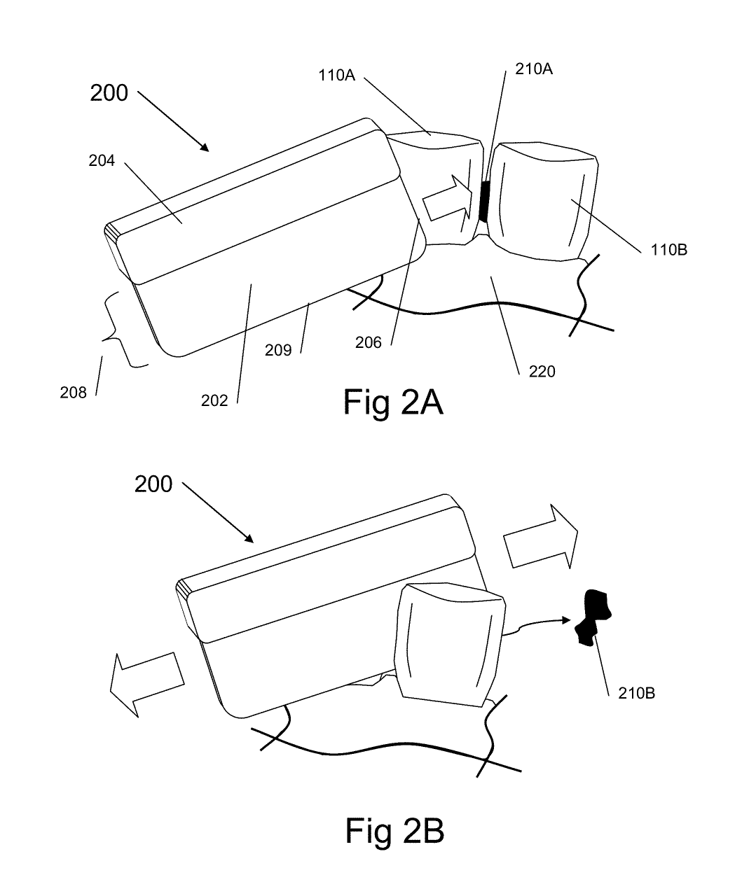

FIGS. 2A and 2B shows, in simplified form, the use of a prophylaxis strip to remove a foreign object 210A, stuck between a person's teeth 110A, 110B. In FIG. 2A the end 206 of the prophylaxis strip assembly 200 is being used to push a foreign object 210A lodged between someone's teeth 110A, 110B. In FIG. 2B, the foreign object 210B has been successfully dislodged. The foreign object 210B was dislodged by using an end 206 of a prophylaxis strip assembly 200 to push against the foreign object 210A. The prophylaxis strip assembly 200 is comprised of a prophylaxis strip 202 and an added structural support 204 along the longitudinal length of the prophylaxis strip 202, such that a portion the end 206 of prophylaxis strip 202, approximately the height of a person's teeth or greater, is uncovered by the added structural support 204. The uncovered portion defining a depth of the prophylaxis strip 209, which is the distance from the structural support 204 to the base of the prophylaxis strip 209.

This configuration is advantageous because it provides enough structural support such that objects can be pushed from between a person's teeth while still allowing flexible materials to be used for the prophylaxis strip so that is can bend around the contours of the patient's teeth to allow the walls of the teeth to be effectively cleaned. [Note: the structural supports herein need not be configure to produce a consistent depth of the prophylaxis strip and bowed configuration as well as angled configuration are also anticipated, the point being that at least some portion of the end of the prophylaxis strip is unblocked by the structural support.

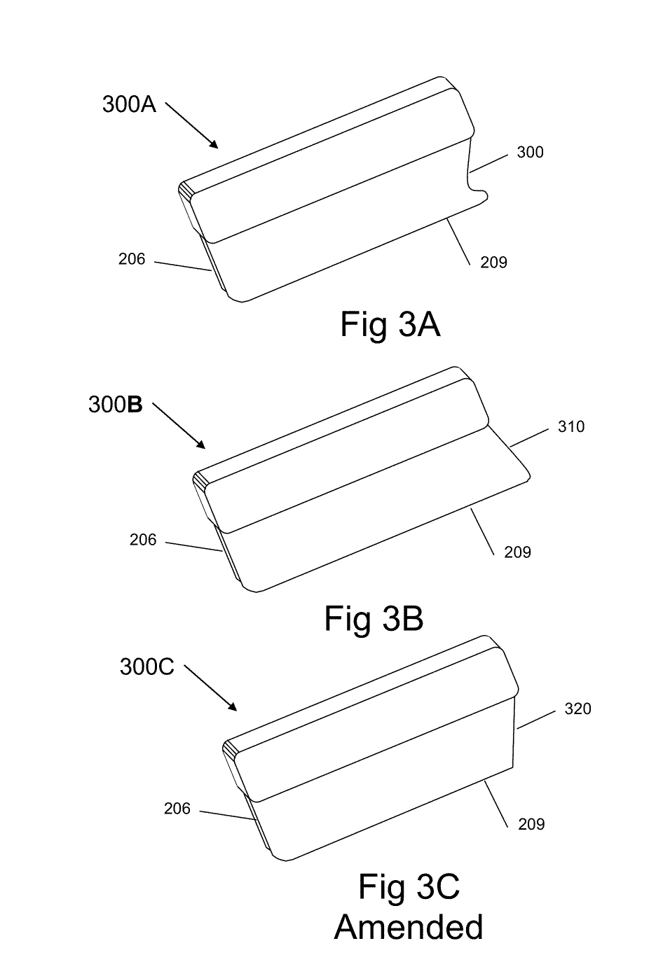

FIG. 3A-3C shows, in simplified form, alternate versions 300A, 300B, 300C of prophylaxis strip assembly 200 from FIG. 2A-2B, with the difference being that rather than having a square end 206 (substantially perpendicular to the base 209) on both sides, prophylaxis strip assembly 300A in FIG. 3A has a hooked end 400 on one side, the prophylaxis strip assembly 300B in FIG. 3B has an end 410 angled outward on one side (an acute angle with respect to the base), and the prophylaxis strip assembly 300C in FIG. 3C has an end 320 that is angled inward on one side (an obtuse angle with respect to the base). In this regard, it should be understood that the various ends 206, 300, 310, 320 are representative of typical end configurations for purposes of understanding and that various end combinations could be used at different ends of the strip. It is to be understood that other end configuration, whether standard or proprietary, can be used to the same or similar effect for pushing (or prying) foreign objects from between someone's teeth. Again, the important aspect being the ability to remove a foreign object by using the end, not the particular configuration of the end used.

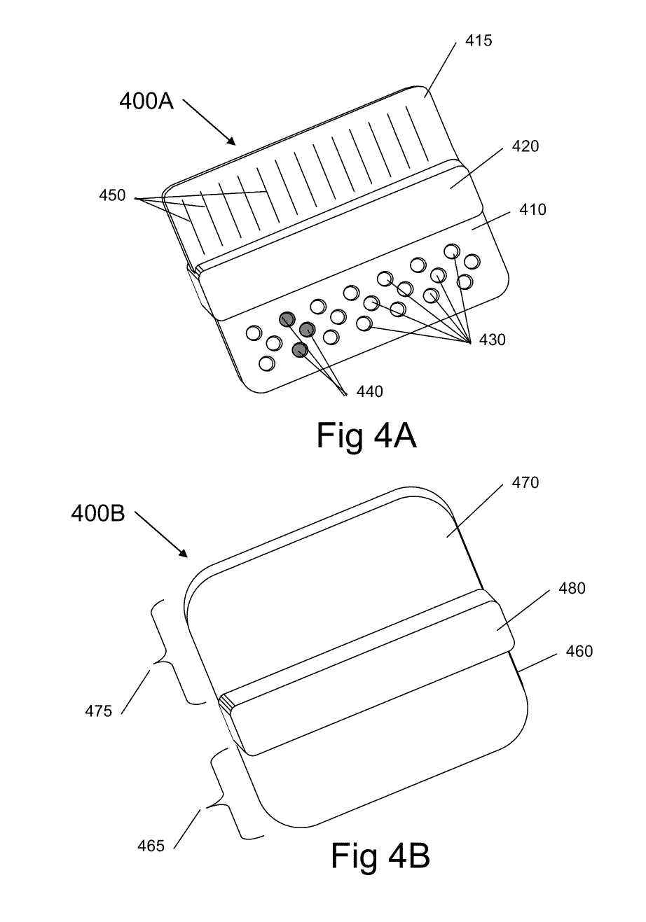

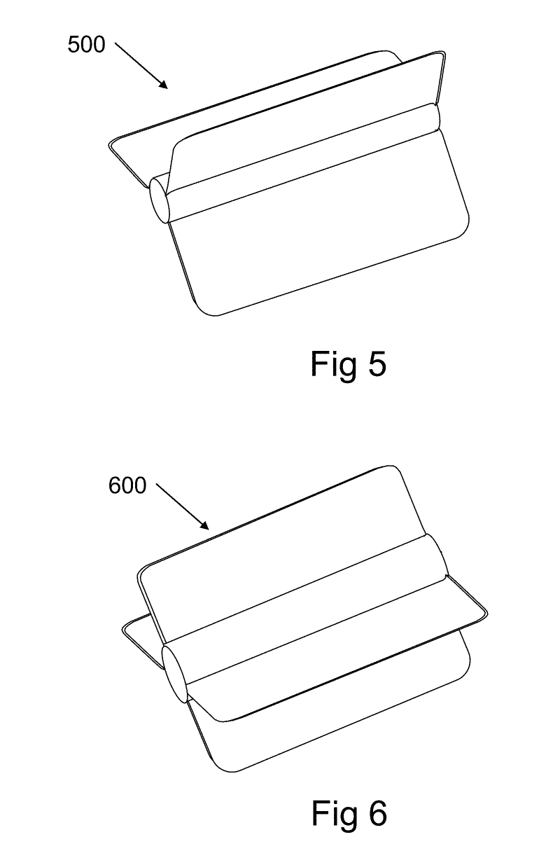

While a one-sided prophylaxis strip offer numerous advantageous, a multi-sided prophylaxis strip adds even more advantageous. FIG. 4A-4B show, in simplified form representative two-sided prophylaxis strip assemblies. FIG. 5 shows, in simplified form representative three-sided prophylaxis strip assembly. FIG. 6 shows, in simplified form representative four-sided prophylaxis strip assembly. The advantage being that with multi-sided configuration the various sides of the assembly can have the same or different properties. A few examples of variations are that the thickness of the strip could be varied from side to side, which could advantageously accommodate varying gaps between teeth and/or provide different stiffness/flexibility of the strip; the material of the strip could be varied from side to side, which could also advantageously be used to provide varying stiffness/flexibility of the strip; the ends of the strips could be different combinations; the depth of the strip could be varied, which advantageously allows different heights of the teeth to be accommodated; and the texture of the strip could be varied, which advantageously allows the strip to perform different functions.

FIG. 4A shows a two-sided prophylaxis strip assembly 400A that has two sides 410, 415 separated by a structural support 420. On the one side 410 are a plurality of holes 430, which advantageously allow material to be gripped within the holes and aids in removing foreign matter, particularly small particulate, from between the teeth. Additionally, some of the holes 430 are shown as filled with fill material 440. A few examples of fill material 440 that might be used included abrasives, toothpaste, whitening agents, and flavorings to name a few possibilities. The other side 415 is shown with texture 450 added to the strip, which advantageously can be used to produce different cleaning properties. The texture 450 is shown as running perpendicular to of the support structure; however, other textures such as parallel, diagonal, crosshatched, and grit finishes are also anticipated.

FIG. 4B also shows a two-sided prophylaxis strip assembly 400B that has two sides 460, 470 separated by a structural support 480. The difference being that while the structural support 420 of FIG. 4A is shown as bisecting the two sides 410, 415, the structural support 480 of FIG. 4B is shown as attached to the surface of the prophylaxis strip assembly 400B and thus creating the two sides.

Additionally, in FIG. 4B each side 460, 470 is shown as having different depths 465, 475, which, as previously mentioned can be advantageously utilized to accommodate different teeth heights that may occur throughout someone's mouth or to accommodate differences between users.

It should be noted that the methods of attachment of any of the structural supports to the prophylaxis strip (or vice versa) presented herein include both standard and proprietary techniques such as a physical adhesive; chemical bonding, heat sealing, ultra sonic bonding, and (with the exception of FIG. 4B) mechanical attachments (e.g. a press fit). In this regard, it should be understood that the methods of attachment are representative of typical, known methods of attachment for purposes of understanding. It is to be understood that other methods of attachment whether standard or proprietary can be used to the same or similar effect for attaching the prophylaxis strip to the structural support, again, the important aspect being the ability to the prophylaxis strip to the structural support, not the particular methods of attachment or protocol used.

Additionally, it is worth pointing out that the structural supports presented herein need not necessarily be a separate component and may simply be a thicker areas of the prophylaxis strip or represent areas of the prophylaxis strip that have been folded over and then bonded. The point being that the structural support in combination with the prophylaxis strip provide enough rigidity such that the end of the prophylaxis strip can be used to push objects from between someone's teeth.

Finally, it is to be understood that various different variants of the invention, including representative embodiments and extensions have been presented to assist in understanding the invention. It should be understood that such implementations are not to be considered limitations on either the invention or equivalents except to the extent they are expressly in the claims. It should therefore be understood that, for the convenience of the reader, the above description has only focused on a representative sample of all possible embodiments, a sample that teaches the principles of the invention. The description has not attempted to exhaustively enumerate all possible permutations, combinations or variations of the invention, since others will necessarily arise out of combining aspects of different variants described herein to form new variants, through the use of particular hardware or software, or through specific types of applications in which the invention can be used. That alternate embodiments may not have been presented for a specific portion of the description, or that further undescribed alternate or variant embodiments may be available for a portion of the invention, is not to be considered a disclaimer of those alternate or variant embodiments to the extent they also incorporate the minimum essential aspects of the invention, as claimed in the appended claims, or an equivalent thereof.

What is claimed is:

1. A device for cleaning interproximal surfaces and contact areas between teeth comprising:
at least one thin flexible strip with a longitudinal length and an overall thickness that fits between the teeth;
the strip further comprising a first lateral surface and a second lateral surface on opposite sides of the strips thickness and such that when the strip is longitudinally inserted between two teeth the first lateral surface is facing towards one of teeth and a second lateral surface is facing towards the other;
the strip further comprising a base such that when the strip is longitudinally inserted between two teeth the base would be facing towards the gums between the two teeth;
the strip further comprising two ends that are on opposite ends of the longitudinal length and one of the ends is a first end;
a support member integral with the strip along its longitudinal length, which is configured to limit the ability of the strip to bend towards either the first or second lateral surface, without impeding the ability of the base of the strip to be inserted between the teeth, to a predetermined depth, and without impeding the ability of the first end to be inserted between the teeth, wherein the first end can be used to push material from between the teeth.

2. The device of claim 1, wherein the first end and the base form and angle that is substantially perpendicular.

3. The device of claim 1, wherein the first end and the base form and angle that is acute.

4. The device of claim 1, wherein the first end and the base form and angle that is obtuse.

5. The device of claim 1, wherein the first end is in the configuration of a hook.

6. The device of claim 1, wherein the device comprises at least two strips and wherein the device is a multi-sided device.

7. The device of claim 1, wherein the first lateral surface is textured.

8. The device of claim 1, wherein the strip has holes running between the first lateral surface and the second lateral surface.

9. The device of claim 8, wherein the strip has holes are filled with flavoring.

10. The device of claim 8, wherein the strip has holes are filled with one or more toothpaste or whitening agents.

11. The device of claim 8, wherein the strip has holes are filled with abrasives.

12. The device of claim 8, wherein the support member is made from folded material from the strip.
